(19) United States
(12) Patent Application Publication
(10) Pub. No.: US 2017/0315934 A1
(43) Pub. Date: Nov. 2, 2017

(54) Method and System for Faster Policy Based File Access for Storage Hosted by a Network Storage System

(71) Applicant: NetApp, Inc., Sunnyvale, CA (US)

(72) Inventors: Mark Muhlestein, Sunnyvale, CA (US); Chinmoy Dey, Bangalore (IN)

(21) Appl. No.: 15/142,217

(22) Filed: Apr. 29, 2016

(51) Int. Cl. G06F 12/14; G06F 3/06

(52) U.S. Cl. CPC G06F 12/1458; G06F 3/067; G06F 3/0622; G06F 3/0637

(57) ABSTRACT

Systems, devices, methods, and computer program products are provided for implementing storage access policies within a storage system on behalf of external computing agents. A storage system receives a set of storage rules from a partner computing system. The set of storage rules define a storage access policy that allows specific users or user groups to perform storage access operations within a file system hosted by the storage system. The storage system stores the storage access policy on behalf of the partner computing system. Upon receiving a storage access request from an external client computing system, the storage system compares the storage access request against the storage access policy to allow the storage access request or transmit an event notification of the storage access request to the partner computing system.

### TECHNICAL FIELD

The present disclosure relates generally to storage systems and more specifically to a technique for enabling a storage system to implement storage access policies on behalf of an external agent computing system, enabling faster and more efficient policy-based file access.

### BACKGROUND

Business entities and consumers are storing an ever increasing amount of digital data. For example, many commercial entities are in the process of digitizing their business records and other data, for example by hosting large amounts of data on web servers, file servers, and other databases. Techniques and mechanisms that facilitate efficient and cost effective storage of vast amounts of digital data are being implemented in storage systems. A storage system can be connected to and host multiple storage devices multiple storage devices, such as physical hard disk drives, solid state drives, networked disk drives, as well as other storage media. Client computing systems can connect to the storage system to access and manipulate files on the multiple storage devices. Computing systems (referred to herein as “partner computing systems”) operated by third party partners specify storage access policies that define the scope of allowable file access by the client computing systems. For example, partner computing systems may include administrative computing servers of a business organization that manages a storage system to offer networked storage capabilities to users (e.g., employees or subscribers of the networked storage) of client computing devices. The partner computing system may control storage access policies for individual client computing devices or users of the client computing devices (e.g., when the partner computing system is an administrative server for employees of an organization). In another example, the partner computing system may include a business entity that manages a storage system to offer data content on an on-demand basis to numerous client computing devices that are not controlled by the business entity.

While storage systems provide partner computing systems the ability to offer networked storage capabilities to client computing devices, current storage systems, lack the ability to identify the users that have access to hosted storage, lock down sensitive content, and monitor the access of specific data. Instead, to implement the storage access policies, the storage system is required to transmit to the partner computing system event notifications about every storage access request received from client computing systems. The partner computing system can determine whether to allow or disallow the file access and return instructions to the storage system for allowing or disallowing the storage access. For example, consider a partner computing system that is implementing a file-access blocking solution, in which specific users are blocked from accessing certain identified files. Current storage systems generate notifications for each and every registered file operation for each and every home directory from client computing systems. With an increasing number of instances of client access to data hosted by the storage system, the number of event notifications and required processing by the partner computing system increases, causing performance penalties and increased latency for handling each file access request.

It is desirable to have a new method and system that allows a storage system to implement storage access policies on behalf of a partner computing system without having to transmit to the partner computing system event notifications about every storage access request received from client devices associated with the partner computing system.

### BRIEF DESCRIPTION OF THE DRAWINGS

FIG. 1 is a block diagram illustrating an example of a clustered network environment in which multiple storage systems connected over a data fabric provide client computing systems access to hosted storage, according to certain exemplary embodiments.

FIG. 2 is a block diagram illustrating an example data storage system implementing a storage access policy module, according to certain exemplary embodiments.

FIG. 3 is an example of a storage rule repository comprising an example storage access policy, according to certain exemplary embodiments.

FIG. 4 is a flow chart illustrating an example method for implementing a storage access policy by a data storage system, according to certain exemplary embodiments.

### DETAILED DESCRIPTION

Certain embodiments provide systems and methods for enabling a storage system to implement storage access policies on behalf of external computing agents. The external computing agents are referred to herein as partner computing systems, which may be operated by a vendor or network administrator that specifies one or more storage access policies for allowing or denying storage requests from client computing devices. The partner computing systems may be part of the same business organization as the client computing devices and manage storage access policies of a storage system to provide network storage capabilities to the individual computing devices (e.g., where the partner computing system is operated by the company network administrator for employees using client computing devices). In other embodiments, the partner computing systems may manage storage access policies of a storage system to provide network storage capabilities to client computing devices unaffiliated with the partner computing systems (e.g., where the partner computing system is operated by a cloud storage provider for storage access by various businesses or other entities connected to the Internet).

In embodiments disclosed herein, the partner computing system specifies storage access policies that are implemented by the storage system. For example, the storage system may receive a sequence of storage rules from a partner computing system. The sequence of storage rules defines a storage access policy that allows specific users and/or user groups and/or client devices to perform certain file operations within a file system that is hosted by the storage system. The storage system includes a storage access policy module that can interpret the sequence of storage rules and execute the rules to implement the storage access policy. For example, when a storage access request is received from an external client system, the storage system executes the sequence of rules and compares the storage access request against the storage access policy stored within the storage system on behalf of the partner computing system. If the storage access request satisfies all of the storage rules, the storage system allows the client access and stores a result of the storage access request within a rule set repository. The storage rules can also specify that the storage system should notify the partner computing system of storage access requests that fulfill certain conditions. For example, the storage rules can specify that a storage access notification is transmitted to the partner computing system if the request does not satisfy one of the storage rules. By implementing a storage access policy module, the storage system is able to make storage access decisions on behalf of the partner computing system without having to transmit storage access notifications to the partner computing system for every storage access.

For example, through embodiments described herein, the storage system can implement a storage access policy that allows specific clients to store up to 2 GB of data files having an extension of .mp3. The sequence of storage rules may specify that the storage system should allow client modification of the file system (e.g., adding .mp3 files) up to a disk quota of 2 GB. In this example, the sequence of storage rules also specifies that the partner computing system should be notified if any client storage access results in exceeding the storage threshold of 2 GB of .mp3 files. Upon receiving storage access requests from client computing systems (e.g., upon receiving requests to create or copy .mp3 files into the data storage hosted by the storage system), the storage system executes the storage access policy and allows the storage access requests without having to transmit notifications to the partner computing system and without requiring external processing of the storage rules. Once the threshold of 2 GB of .mp3 storage is reached, the storage system transmits event notifications regarding subsequent storage access requests for creation/copying of .mp3 files to the partner computing system.

By implementing the storage access policy on behalf of the partner computing system, overall storage access performance is increased as the majority of storage access requests for the creation or manipulation of files hosted by the storage system are allowed or denied without requiring external processing. Embodiments herein thus provide faster storage access for client computing systems and relieve computing processing resources on the partner computing systems.

By implementing the storage access policy on behalf of the partner computing system, the partner computing system is able to specify a more complex sequence of storage instructions that would otherwise not be possible in a conventional storage system that requires transmission of event notifications on every storage access request. Specifically, the storage system in the disclosed embodiments is able to process more complex rules that rely on specific information available only to the storage system - parameters that would not be practical to transmit to the partner computing system. For example, the storage system may maintain sets of user groups, each user group listing multiple user identifiers for users that are members of the respective user groups. Information identifying all of the user groups and the individual user identifiers associated with each user group may be too large to transmit to the partner computing system. Thus, conventional third party storage access policy implementations do not provide for complex rules that are based on large sets of data (such as information on user groups). Embodiments described herein enable the storage system to implement storage access policies that require a more complex sequence of storage instructions or that require access to large sets of data stored at the storage system. For example, embodiments herein enable a storage system to implement storage access policies that allow file access if a user requesting a file is a member of a privileged group.

Continuing the example above, a sequence of storage rules received from the partner computing system may specify that a privileged directory may only be accessed by members of a privileged user group. A storage access request from a client computing system includes, for example, a user identifier identifying a user of the client computing system, a IP identifier identifying the internet protocol address of the client computing system, and other identifiers. Upon receiving a storage access request from a client computing system, the storage system executes the storage access policy on behalf of the partner computing system and determines if the user identifier included in the storage access request is one of the user identifiers comprising the privileged user group. If the client storage access request satisfies all of the storage rules, the storage system allows the storage access request without having to transmit the list of user groups or information on the members of each user group to the partner computing system. If not, then the storage access request is denied. In some embodiments, if the storage access request does not satisfy one or more storage rules, the storage system transmits a notification to the partner computing system informing the partner computing system about the storage access request. The notification may comprise forwarding the storage access request to the partner computing system. The storage system may receive a response to the notification from the partner computing system instructing the storage system to allow or deny the request.

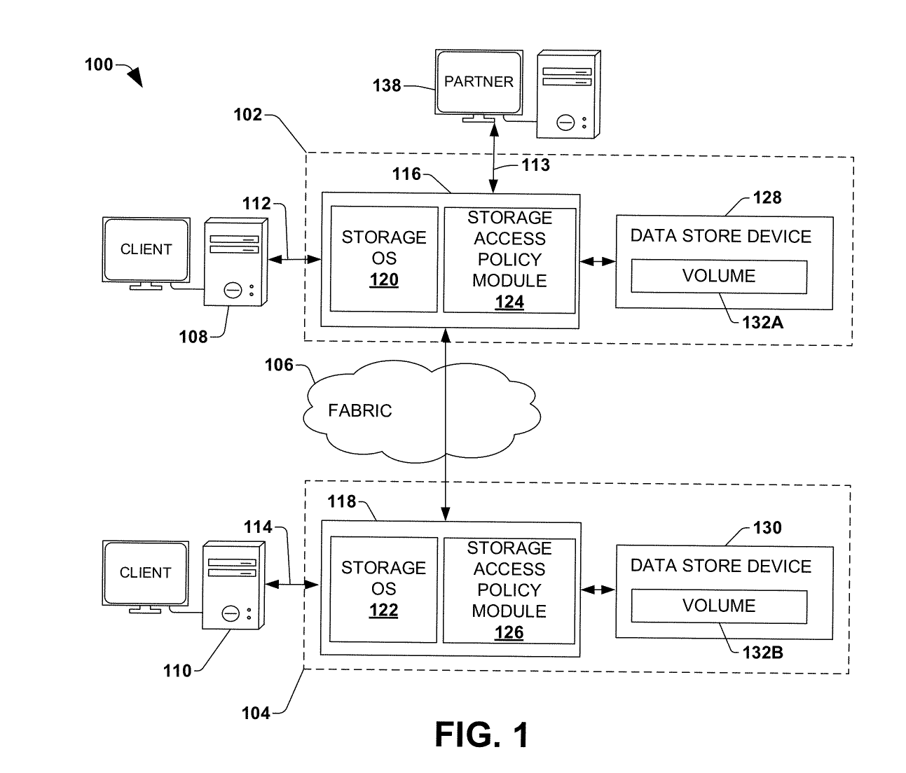

Referring now to the drawings, FIG. 1 is a block diagram illustrating an example of a clustered network environment or a network storage environment 100 that may implement the embodiments and techniques described herein. The example environment 100 comprises data storage systems 102 and 104 that are coupled over a cluster fabric 106, such as a computing network embodied as a private Infiniband or Fibre Channel (FC) network facilitating communication between the storage systems 102 and 104 (and one or more modules, components, etc. therein, such as, storage nodes 116 and 118, for example). While two data storage systems 102 and 104 and two storage nodes 116 and 118 are illustrated in FIG. 1, any suitable number of such components is contemplated. In an example, storage nodes 116, 118 comprise storage controllers (e.g., storage node 116 may comprise a primary or local storage controller and storage node 118 may comprise a secondary or remote storage controller) that provide client devices, such as client computing devices 108, 110 (also referred to as “host devices”), with access to data stored within data storage devices 128, 130. Data storage devices 128, 130 include, for example, disks or arrays of disks, flash memory, flash arrays, and other forms of data storage. Storage nodes 116, 118 communicate with the data storage devices 128, 130 according to a storage area network (SAN) protocol, such as Small Computer System Interface (SCSI) or Fiber Channel Protocol (FCP), for example.

The data stored in various data blocks in data storage devices 128, 130 can be partitioned into one or more volumes 132A-B. In one embodiment, the data storage devices 128, 130 comprise volumes 132A-B, which is an implementation of storage of information onto disk drives or disk arrays or other storage (e.g., flash) as a file-system for data, for example. Volumes can span a portion of a disk, a collection of disks, or portions of disks, for example, and typically define an overall logical arrangement of file storage on disk space in the storage system. In one embodiment a volume can comprise stored data as one or more files that reside in a hierarchical directory structure within the volume. The cluster fabric 106 enables communication between each of the storage systems 102, 104 within the networked storage environment 100, allowing storage nodes 116, 118 to access data on both data storage devices 128, 130.

In the illustrated example, one or more client computing devices 108, 110 which may comprise, for example, personal computers (PCs), computing devices used for storage (e.g., storage servers), and other computers or peripheral devices (e.g., printers), are coupled to the respective data storage systems 102, 104 by storage network connections 112, 114. Similarly, a partner computing system 138 is coupled to a storage node 116 via network connection 113. Network connections may comprise a local area network (LAN) or wide area network (WAN), for example, that utilizes Network Attached Storage (NAS) protocols, such as a Common Internet File System (CIFS) protocol or a Network File System (NFS) protocol to exchange data packets. The client computing devices 108, 110 and partner computing device 138 may be general-purpose computers running applications or computer servers for accessing and managing data storage on data storage devices 128, 130. In some embodiments, client computing devices 102, 104 access data on data storage devices 128, 130 using a client/server model for exchange of information. That is, the client computing device 108, 110 may request data from volumes 132A-B in the data storage system 102, 104 (e.g., by requesting data stored on data storage device 128, 130 managed and hosted by the data storage system 102, 104), and the data storage systems 102, 104 may return results of the request to the client computing device 108, 110 via one or more network connections 112, 114. Each of the client computing devices 108, 110 can be networked with both of the data storage systems 102, 104 in the network cluster 100 via the data fabric 106. For example, a client computing device 108 may request data storage access to manipulate files in data storage device 130 managed by data storage node 118. Storage node 116 provides the communication between client computing device 108 and storage node 118 via data fabric 106.

Storage nodes 116, 118 include various functional components that coordinate to provide client computing devices 108, 110 access to data blocks within data storage devices 128, 130. Storage nodes 116, 118 include, for example, a memory device that can execute program code for performing operations described herein. One or more processors in storage nodes 116, 118 execute program code for implementing storage operating systems 120, 122. The storage operating systems 120, 122 manage data access operations between the client computing devices 108, 110 and the data storage devices 128, 130. For example, the storage operating systems 120, 122 allocate blocks of data across data storage devices 128, 130 and partition the data blocks into the one or more volumes 132A-B and assign the volumes 132A-B to client computing devices 108, 110. The storage nodes 116, 118 also include program code defining storage access policy modules 124, 126. One or more processors in the storage nodes 116, 118 execute program code for the storage access policy modules 124, 126 to receive and execute the storage access policies from the partner computing system 138. For example, as described in more detail below, the storage access policy module 124 receives a sequence of storage rules from the partner computing device 138, the sequence of storage rules defining a storage access policy. The storage access policy module 124 can also verify the storage functionality rules received from the partner computing device 138 adhere to a defined storage rule syntax and store the sequence of storage rules within a storage rule repository. Further, upon receiving a storage access request from a client computing device 108, 110, the storage access policy module 124 executes the storage rules to allow or deny storage access by client computing devices 108, 110 or transmit a notification of the storage access back to partner computing device 138. While both data storage systems 102, 104 are shown to include storage nodes 116, 118 with storage access policy modules 124, 126, in some embodiments one of the data storage systems (e.g., data storage system 102) may include the storage access policy module 124 and handle storage access policies for all storage systems 102, 104 in the clustered network environment 100.

While partner computing system 138 is shown as communicating with storage system 102 for illustrative purposes, one or more partner computing systems 138 may also communicate with other storage systems (i.e. storage system 104) in the clustered network environment 100. Further while one partner computing system 138 is shown as communicating with the storage system 102, multiple partner computing systems can communicate with the storage system 102. Each of the storage systems 102, 104 includes a storage access policy module 124, 126, allowing sets of storage rules received from the partner computing system 138 to be stored on any of the storage systems 102, 104 in the clustered network environment 100.

While a clustered network environment 100 involving multiple storage systems 102, 104 are shown for exemplary purposes, it should be appreciated that the techniques described herein may also be implemented in a non-cluster network environment involving a single storage system, and/or a variety of other computing environments, such as a desktop computing environment. It will be further appreciated that the data storage systems 102, 104 in clustered network 100 are not limited to any particular geographic areas and can be clustered locally and/or remotely. Thus, in one embodiment a clustered network 100 can be distributed over a plurality of storage systems and/or nodes located in a plurality of geographic locations; while in another embodiment the clustered network 100 includes data storage systems 102, 104 residing in a same geographic location (e.g., in a single onsite rack of data storage devices).

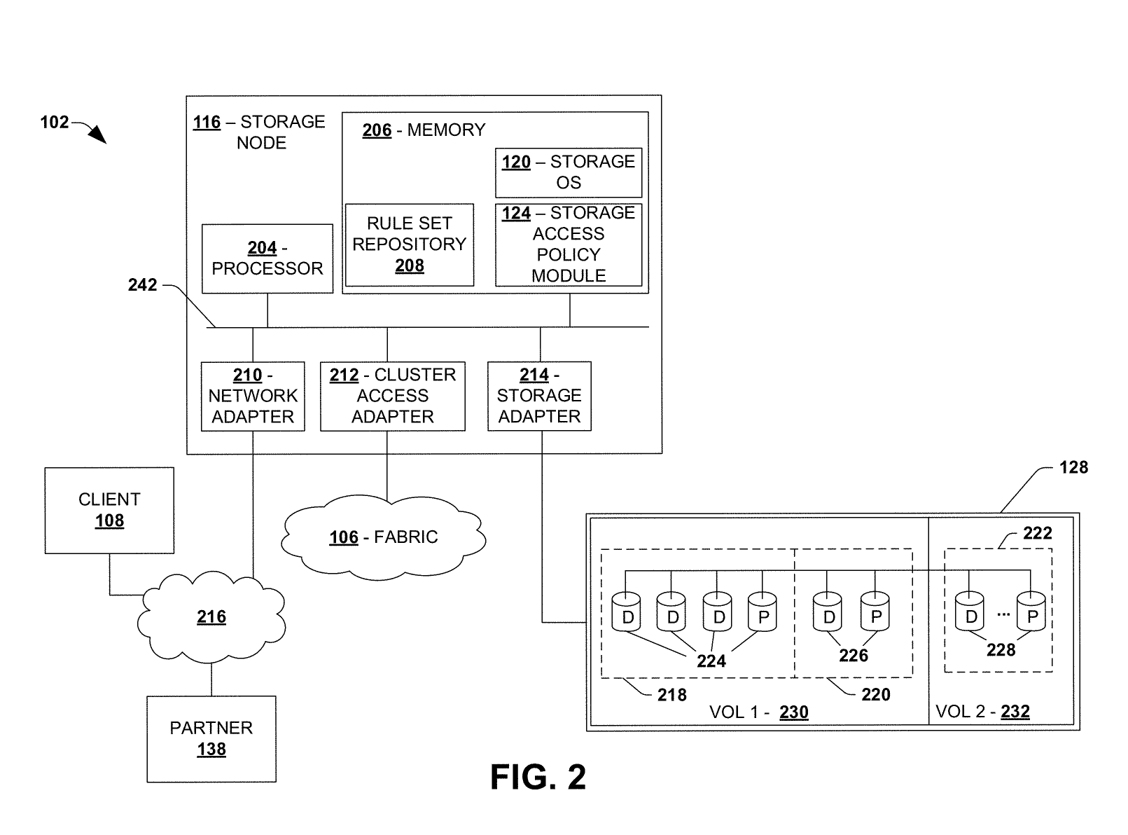

FIG. 2 is an illustrative example of the data storage system 102, providing further detail of an embodiment of components that may implement one or more of the techniques and/or systems described herein. The example data storage system 102 comprises a storage node 116 and a data storage device 128. The storage node 116 may be a general purpose computer, for example, or some other computing device particularly configured to operate as a storage server. A client computing device 108 can be connected to the storage node 116 over a network 216, for example, to provide access to files and/or other data stored on the data storage device 128. In an example, the storage node 116 comprises a storage controller that provides client computing device 108 with access to data stored within data storage device 128. As described with respect to FIG. 1, the storage node 116 may also receive storage access requests from client computing device 110 (not shown in FIG. 2) via data fabric 106. The storage node 116 comprises one or more processors 204, a memory 206 (i.e. a non-transitory computer readable memory), a network adapter 210, a cluster access adapter 212, and a storage adapter 214 interconnected by a system bus 242. The storage node 116 also includes a storage operating system 120 and a storage access policy module 124 installed in the memory 206, both described above with reference to FIG. 1.

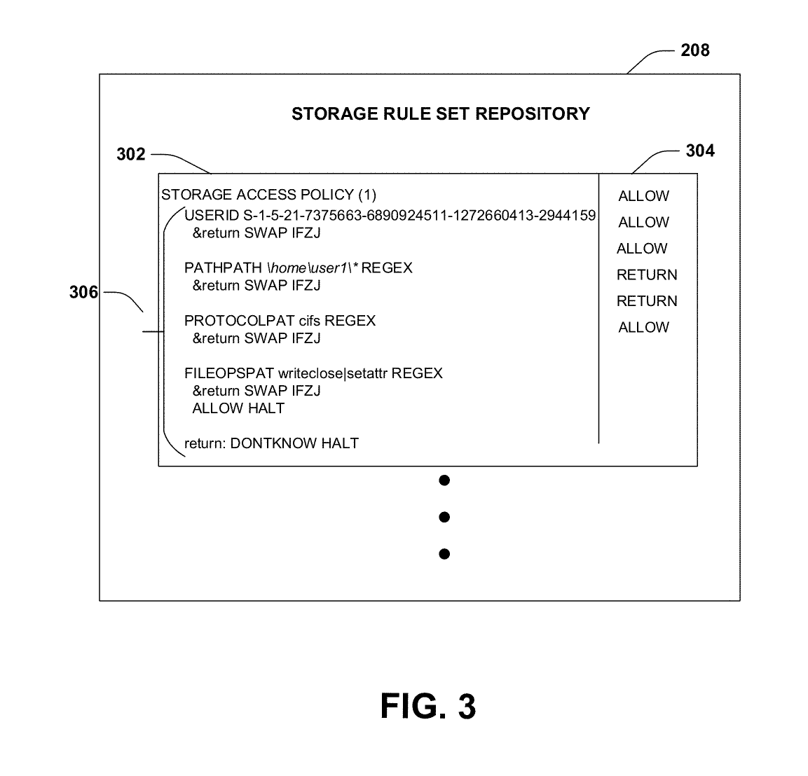

The storage node 116 also includes a rule set repository 208 stored within the memory 206. The rule set repository 208 includes a database of stored storage rules received from the partner computing system 138. Upon receiving a storage access request from client computing device 108, the storage access policy module 124 executing in the storage node 116 compares the storage access request against sets of storage rules stored in the rule set repository 208. If the storage access request satisfies the storage rules in a storage access policy, the storage access policy module 124 allows the storage request by retrieving or manipulating the requested data in data storage device 128 (as described further below). Additionally, the storage access policy module 124 stores the result of the storage access request (e.g., whether the request was allowed, denied, or a notification regarding the request was transmitted to the partner computing device 138) within the rule set repository 208. The results of multiple storage access requests may be stored for example, in rule set repository 208. An example of a set of storage rules and the corresponding results from subsequent client storage access request is shown in FIG. 3 below. Note that while the rule set repository 208 is shown as included in the memory 206 of storage system 102, in other embodiments, the rule set repository 208 may be stored in a storage device remote from the storage system 102 and accessible by the storage system 102.

By storing the data access rules and results of client storage access requests in the non-transitory memory 206, the partner computing system 138 may store multiple storage access policies within the storage node 116 in a non-volatile manner. The partner computing system 138 can thus retrieve a list of the current storage rules and results of any prior client storage access requests from the rule set repository 208, even after the storage node 116 or storage system 102 reboots.

The processor 204 may comprise a microprocessor, an application-specific integrated circuit (“ASIC”), a state machine, or other processing device. The processor 204 can include any of a number of processing devices, including one. Such a processor 204 can include or may be in communication with a computer-readable medium (e.g. memory 206) storing instructions that, when executed by the processor 204, cause the processor to perform the operations described herein for implementing storage rules on behalf of partner computing system 138.

The memory 206 can be or include any suitable non-transitory computer-readable medium. The computer-readable medium can include any electronic, optical, magnetic, or other storage device capable of providing a processor with computer-readable instructions or other program code. Non-limiting examples of a computer-readable medium include a floppy disk, CD-ROM, DVD, magnetic disk, memory chip, ROM, RAM, an ASIC, a configured processor, optical storage, magnetic tape or other magnetic storage, or any other medium from which a computer processor can read instructions. The program code or instructions may include processor-specific instructions generated by a compiler and/or an interpreter from code written in any suitable computer-programming language, including, for example, C, C++, C#, Visual Basic, Java, Python, Perl, JavaScript, and ActionScript. The storage system 102 can execute program code that configures the processor 204 to perform one or more of the operations described herein.

The data storage device 128 may comprise storage devices, such as disks 224, 226, 228 of a disk array 218, 220, 222. It will be appreciated that the techniques and systems, described herein, are not limited by the example embodiment. For example, disks 224, 226, 228 may comprise any type of mass storage devices, including but not limited to magnetic disk drives, flash memory, and any other similar media adapted to store information, including, for example, data (D) and/or parity (P) information. The storage devices 224, 226, and 228 are organized into one or more volumes 230, 232.

The network adapter 210 includes the mechanical, electrical and signaling circuitry needed to connect the data storage system 200 to the client computing system 108 over a computer network 216, which may comprise, among other things, a point-to-point connection or a shared medium, such as a local area network. The storage adapter 214 cooperates with the storage operating system 120 executing on the storage node 116 to access information requested by the client computing system 108 (e.g., access data on the storage device 128). The storage adapter 214 can include input/output (I/O) interface circuitry that couples to the disks over an I/O interconnect arrangement, such as a storage area network (SAN) protocol (e.g., Small Computer System Interface (SCSI), iSCSI, hyperSCSI, Fibre Channel Protocol (FCP)). The storage information requested by the client computing system 108 is retrieved by the storage adapter 214 and, if necessary, processed by the one or more processors 204 (or the storage adapter 214 itself) prior to being forwarded over the system bus 242 to the network adapter 210 (and/or the cluster access adapter 212 if sending to another node in the cluster) where the information is formatted into a data packet and returned to the client computing device 108 over the network connection 216 (and/or returned to another node attached to the cluster over the cluster fabric 106).

As described above with respect to FIGS. 1 and 2, the partner computing system 138 transmits sets of storage rules to the storage system 102, and the sets of storage rules are stored in a rule set repository 208. Each set of storage rules defines a particular storage access policy. FIG. 3 is an example of storage rule set repository 208 showing one storage access policy 302. For illustrative purposes, one storage access policy 302 is shown. However, storage rule set repository 302 may include multiple different storage access policies received from a partner computing system 138. Each of the storage access policies corresponds to a different sequence of computer logic that instructs the storage system 102 when to allow client devices 108, 110 (or users access client devices 108, 110) to perform specific file access operations (i.e. for accessing or otherwise manipulating files in data storage devices 128, 130).

FIG. 3 depicts an example of storage access policy 302. The storage access policy 302 includes a set of storage rules 306 that provide the necessary computer logic in the form of a scripting language. Any suitable computer-readable scripting language or programming language may be used for the set of storage rules. The storage access policy 302 allows a specific user to perform certain file access operations within a particular directory of the file system hosted by the storage system 102. Specifically, the set of storage rules 306 indicate that if a particular storage access request is from a particular user (identified by the given user ID) of client computing device 108, the access is for a specific directory path (\home\user1\), the access was received from a client device (e.g., client device 108) using the CIFS protocol, and the access is for file operations of write to file, close file, or set attribute of file, then the storage system 102 should allow the storage access request and halt execution of set of storage rules. The storage access policy 302 also provides that if any of the above conditions are not satisfied, the storage system 102 should return an event notification to the partner computing system 138 indicating the storage access request.

As described above, results of each execution of the storage access policies are also stored in the storage rule set repository 208. FIG. 3 shows example results 304. The example results 304 depict six different storage access requests, each eliciting execution of the storage access policy 302. As shown in the example, the first three storage access requests were allowed, two of the requests resulted in returning event notifications to the partner computing system 138, and the last request was allowed. While the example results 304 shown in FIG. 3 depict whether the access requests were allowed or returned, additional data describing details of the storage access requests can also be stored. For example, the storage system 102 may also store, for each storage access request, a User ID of the user of the client computing requesting the access, a user group identifier identifying the user group that the user belongs to, the specific file or directory that was accessed or for which access was attempted, and the specific file access operation that was attempted.

The specific storage access policy 302 for allowing a specific user to access the /home/user1/ path is shown for illustrative purposes. The different types of storage access policies available in the embodiments herein, however, is not limited. Through embodiments herein, the partner computing system 138 is able to provide complex sets of storage rules defining diverse storage access policies. For example, one storage access policy may specify a sequence of computer logic instructing the storage system 102 to allow creation of all file types with the exception of specific file types (e.g., .mp3 files). The storage access policy may also specify that if any client computing device 108, 110 attempts to create the prohibited file type, the storage system 102 should transmit an event notification to the partner computing system 138 indicating that a computing device attempted to create a prohibited file type on a storage volume 132A or 132B. In some embodiments, the set of storage rules defining the storage access policy specify which specific users or user groups can perform file access operations in the storage volumes 132A-B. The set of storage rules can also define which specific file access operations are allowable operations and which operations should result in an event notification to the partner computing system 138.

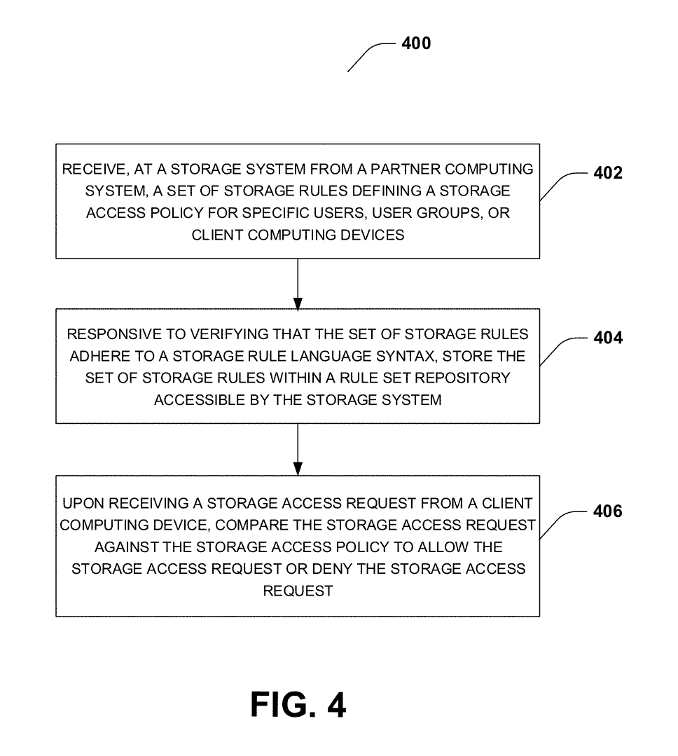

FIG. 4 is a flowchart illustrating an example of a method 400 performed by a storage system 102 for receiving and implementing a storage access policy at a client computing device 108. For illustrative purposes, the method 400 is described with reference to the system implementation depicted in FIGS. 1-2. Other implementations, however, are possible.

The method 400 involves receiving, at a storage system, a set of storage rules from a partner computing system, as shown in block 402. The set of storage rules define a storage access policy for specific users, specific user groups, or specific client computing devices 108, 110. The storage access policy allows the specific users, specific user groups, or specific client computing devices 108, 110 to perform one or more file access operations within a file system hosted by the storage system. For example, the storage system 102 receives a communication over a network from the partner computing system 138. The communication includes a set of storage rules that comprise the logic defining a specific storage access policy.

The received storage access policy indicates one or more specific users (identified by a user ID) or user groups (identified by a user group ID) and/or client device(s) that can perform specific file operations within a file system. The file operations include, for example, creating a file, accessing a file, deleting a file, accessing a directory, modifying file attributes, and other operations routinely made available by storage operating system 120. The file system includes files in a hierarchical directory in volumes 132A-B in data storage devices 128, 130. For example, the set of storage rules may indicate that a first set of users are prohibited from creating files of a prohibited file type, and a second set of users are permitted to create files of the prohibited file type. The set of storage rules may also indicate that, upon determining that a storage access request from a client computing device 108 does not satisfy one or more of the storage rules, an event notification of the storage access request should be transmitted to the partner computing device 138. Additional examples of storage access policies are described above with respect to FIGS. 1-3.

Responsive to verifying that the set of storage rules adhere to a storage rule language syntax, the storage system 102 stores the set of storage rules within a rule set repository accessible by the storage system, as shown in block 404. For example, the storage access policy module 124 may be configured to interpret storage rules provided from the partner computing system 138 according to a particular syntax. The required storage rule language syntax may specify parameters or expressions that define the particular scripting language being used to implement the storage access policies. To determine if a received set of storage rules adhere to the storage rule language syntax, the storage system 102 compares the received set of storage rules with the parameters and expressions provided in the storage rule language syntax. If the set of storage rules adhere to the storage rule language syntax, the set of storage rules are stored within the rule set repository 208. If the set of storage rules do not adhere to the storage rule language syntax, a syntax error notification is transmitted back to the partner computing system 138.

In some embodiments, prior to providing the storage access policies, the partner computing system 138 can define a particular storage rule language syntax and transmit the storage rule language syntax to the storage system 102. The storage system 102 stores the storage rule language syntax in memory 206. In such embodiments, the partner computing system 138 is able to customize the storage rule language syntax and add additional commands, parameters, and expressions to the syntax.

The set of storage rules are stored within the rule set repository 208 on behalf of the partner computing device 138. This allows the partner computing system 138 to offload the processing for storage access policies to the storage system 102, thus decreasing the number of storage access notifications that are required to be transmitted back to the partner computing system 138.

Upon receiving a storage access request from a client computing device, the storage system 102 compares the storage access request against the storage access policy, as shown in block 406. Based on the results of the comparison, the storage system 102 allows or denies the storage access request. In some embodiments, the storage system 102 transmits an event notification of the storage access request to the partner computing system 138 including details of the storage access request.

For example, a client computing device 108 issues a storage access request to storage system 102. The storage access request is for performing an operation on a resource (e.g., to create, view, open, edit, set attributes for, and other operations on a file or directory) in a file system hosted by the storage system 102. To compare the storage access request against the storage access policy, the storage access policy module 124 executes the set of storage rules defining the storage access policy to determine if the storage access request satisfies the set of storage rules. For example, the storage access request includes information such as the user identifier for the user of client computing device 108 issuing the request, the device identifier for the client computing device 108 (e.g., an IP address, MAC address, or other device identifier), the network protocol (e.g., CIFS, SMB) used, the path name of the specific resource in the request (e.g., the directory and file path a particular file or a directory path for a particular directory being requested), and the type of operation being requested. The storage access policy module 124 compares the information in the storage access request with the corresponding expressions in the set of storage rules. Referring back to FIG. 3 as an example, the storage access policy module 124 compares the user identifier included in the storage access request with the USERID storage rule in storage access policy 302. If the user identifier matches the USERID storage rule, the storage access policy module 124 proceeds to the next storage rule. If the user identifier does not match the USERID storage rule, the storage access policy module 124 jumps to the return storage rule.

If the storage access policy module 124 determines that the storage access request satisfies all of the set of storage rules, the storage access policy module 124 allows the storage access request and stores the result of the storage access request within the rule set repository 208. By allowing the storage access request, the storage system 102 does not have to transmit any notification of the request to the partner computing system 138. If the storage access policy module 124 determines that the storage access request does not satisfy one or more of the set of storage rules, the storage system 102 denies the storage access request and/or transmits an event notification of the storage access request to the partner computing system 138. For example, the set of storage rules may specify that, if one or more of the storage access rules are not satisfied, the storage system 102 should deny the storage access request without transmitting any event notification to the partner computing system 138. The storage system 102 stores the result of the storage access request within the rule set repository 208. In other embodiments, the set of storage rules may specify that, if one or more of the storage access rules are not satisfied, the storage system 102 should transmit an event notification to the partner computing system and wait for instructions from the partner computing system 138 specifying whether to allow or deny the request.

The event notification to the partner computing system 138 includes detailed information on the storage access request as described above. In some embodiments, the storage system 102 transmits an event notification to the partner computing system 138 by forwarding the storage access request to the partner computing system 138. The partner computing system 138 may determine whether to allow or deny the request based on the event notification. The storage system 102 can receive instructions from the partner computing system 138 indicating whether to allow or deny the request.

Embodiments herein also provide for additional functions available to a partner computing system 138 for managing the storage access policies and results of storage access requests. For example, in one embodiment, the partner computing system 138 can request results of the storage access requests over a specified period of time. For example, the storage system 102 may receive a request from the partner computing system 138 to retrieve results of previous storage access requests received from client computing devices 108, 110. The request to retrieve the results may also include a specified period of time period. The storage access policy module 124 identifies the storage access requests that were received from client computing devices 108, 110 over the specified period of time and transmits the results of the identified storage access requests to the partner computing system 138.

In some embodiments, the storage system 102 transmits batch reports of the results of previous access requests to the partner computing system 138 at a period of time determined by the partner computing system 138. Instead of transmitting a notification after each denial of a storage access request, the storage system 102 may collect the results of storage access requests within the rule set repository 208 and transmit cumulative results of the storage access requests in a batch form at a time specified by the partner computing device 138. For example, the storage system 102 may transmit batch notifications of storage access requests at a periodic basis as set by the partner computing system 138.

In an additional embodiment, the storage system 102 receives a request from the partner computing system 138 to purge the set of rules from the rule set repository 208. For example, the storage access policy module 124 can provide a list of the current storage access policies (and the associated sets of storage rules defining said storage access policies) to the partner computing system 138. The partner computing system 138 may select one or more of the storage access policies for deletion. Upon receiving the request to purge the selected storage access policies, the storage system 102 deletes the corresponding storage access policies from the storage set repository 208.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

Some embodiments described herein may be conveniently implemented using a conventional general purpose or a specialized digital computer or microprocessor programmed according to the teachings herein, as will be apparent to those skilled in the computer art. Some embodiments may be implemented by a general purpose computer programmed to perform method or process steps described herein. Such programming may produce a new machine or special purpose computer for performing particular method or process steps and functions (described herein) pursuant to instructions from program software. Appropriate software coding may be prepared by programmers based on the teachings herein, as will be apparent to those skilled in the software art. Some embodiments may also be implemented by the preparation of application-specific integrated circuits or by interconnecting an appropriate network of conventional component circuits, as will be readily apparent to those skilled in the art. Those of skill in the art will understand that information may be represented using any of a variety of different technologies and techniques.

Some embodiments include a computer program product comprising a computer readable medium (media) having instructions stored thereon/in that, when executed (e.g., by a processor), cause the executing device to perform the methods, techniques, or embodiments described herein, the computer readable medium comprising instructions for performing various steps of the methods, techniques, or embodiments described herein. The computer readable medium may comprise a non-transitory computer readable medium. The computer readable medium may comprise a storage medium having instructions stored thereon/in which may be used to control, or cause, a computer to perform any of the processes of an embodiment. The storage medium may include, without limitation, any type of disk including floppy disks, mini disks (MDs), optical disks, DVDs, CD-ROMs, micro-drives, and magneto-optical disks, ROMs, RAMs, EPROMs, EEPROMs, DRAMs, VRAMs, flash memory devices (including flash cards), flash arrays, magnetic or optical cards, nanosystems (including molecular memory ICs), RAID devices, remote data storage/archive/warehousing, or any other type of media or device suitable for storing instructions and/or data thereon/in.

Stored on any one of the computer readable medium (media), some embodiments include software instructions for controlling both the hardware of the general purpose or specialized computer or microprocessor, and for enabling the computer or microprocessor to interact with a human user and/or other mechanism using the results of an embodiment. Such software may include without limitation device drivers, operating systems, and user applications. Ultimately, such computer readable media further includes software instructions for performing embodiments described herein. Included in the programming (software) of the general-purpose/specialized computer or microprocessor are software modules for implementing some embodiments.

The various illustrative logical blocks, modules, and circuits described in connection with the embodiments disclosed herein may be implemented or performed with a general-purpose processing device, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processing device may be a microprocessor, but in the alternative, the processor may be any conventional processor, controller, microcontroller, or state machine. A processing device may also be implemented as a combination of computing devices, e.g., a combination of a DSP and a microprocessor, a plurality of microprocessors, one or more microprocessors in conjunction with a DSP core, or any other such configuration

Aspects of the methods disclosed herein may be performed in the operation of such processing devices. The order of the blocks presented in the figures described above can be varied—for example, some of the blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation and are not meant to be limiting.

While the present subject matter has been described in detail with respect to specific examples thereof, it will be appreciated that those skilled in the art, upon attaining an understanding of the foregoing may readily produce alterations to, variations of, and equivalents to such aspects and examples. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method, comprising:
receiving, at a storage system from a partner computing system, a set of storage rules defining a storage access policy for specific users, specific user groups, or specific client devices, the storage access policy allowing the specific users, the specific user groups, or the specific client devices to perform one or more storage access operations within a file system hosted by the storage system;
responsive to verifying that the set of storage rules adhere to a storage rule language syntax, storing the set of storage rules within a rule set repository accessible by the storage system; and
upon receiving a storage access request from a client computing device, comparing the storage access request against the storage access policy by executing the set of storage rules to allow or deny the storage access request according to the set of storage rules.

2. The method of claim 1, wherein executing the set of storage rules comprises: responsive to determining that the storage access request satisfies all of the set of storage rules, allowing the storage access request and storing a result of the storage access request within the rule set repository.

3. The method of claim 1, wherein executing the set of storage rules comprises: responsive to determining that the storage access request does not satisfy one or more of the set of storage rules, denying the storage access request and storing a result of the storage access request within the rule set repository.

4. The method of claim 1, wherein the one or more storage access operations include a file create operation for creating a new file within the file system, and wherein the set of storage rules defining the storage access policy further specify a prohibited file type that can only be created by the specific users.

5. The method of claim 4, wherein the storage access request includes a user identifier identifying another user, the other user not one of the specific users, and the storage access request is for creation of the prohibited file type, and wherein executing the set of storage rules comprises: denying the storage access request.

6. The method of claim 1, further comprising:
receiving a request from the partner computing system to retrieve results of previous storage access requests received by the storage system over a specified time period;
identifying the previous storage access requests over the specified time period and the results of the previous storage access requests, the results indicating whether each of the storage access requests were allowed or denied; and
transmitting the previous storage access requests to the partner computing system.

7. The method of claim 1, further comprising:
responsive to a request from the partner computing system to purge the set of rules from the rule set repository, deleting the set of storage rules;
receiving a second storage access request from the client computing device; and
transmitting an event notification of the second storage access request to the partner computing system.

8. The method of claim 1, wherein the set of storage rules defining the storage access policy further specify a set of directories for the one or more file access operations and a maximum disk storage quota for at least one of the set of directories.

9. The method of claim 8, wherein executing the set of storage rules comprises: responsive to determining that the storage access request is for creating a file in the one of the set of directories associated with a maximum disk storage quota, the file having a file size greater than the maximum disk storage quota, or is for increasing an existing file size by an amount greater than the maximum disk storage quota, transmitting the event notification of the storage access request to the partner computing system.

10. A non-transitory computer-readable medium having stored thereon instructions for performing a method comprising machine executable code which when executed by at least one machine, causes the machine to:
receive, at a storage system from a partner computing system, a set of storage rules defining a storage access policy for specific users, specific user groups, or specific client computing devices, the storage access policy allowing the specific users, the specific user groups, or the specific client computing devices to perform one or more storage access operations within a file system hosted by the storage system;
responsive to verifying that the set of storage rules adhere to a storage rule language syntax, store the set of storage rules within a rule set repository accessible by the storage system; and
upon receiving a storage access request from a client computing device, compare the storage access request against the storage access policy by executing the set of storage rules to allow or deny the storage access request according to the set of storage rules.

11. The non-transitory computer-readable medium of claim 10, wherein executing the set of storage rules comprises: responsive to determining that the storage access request satisfies all of the set of storage rules, allowing the storage access request and storing a result of the storage access request within the rule set repository.

12. The non-transitory computer-readable medium of claim 10, wherein executing the set of storage rules comprises: responsive to determining that the storage access request does not satisfy one or more of the set of storage rules, denying the storage access request and transmitting the event notification of the storage access request to the partner computing system.

13. The non-transitory computer-readable medium of claim 10, wherein the one or more storage access operations include a file create operation for creating a new file within the file system, and wherein the set of storage rules defining the storage access policy further specify a prohibited file type that can only be created by the specific users.

14. The non-transitory computer-readable medium of claim 13, wherein the storage access request includes a user identifier identifying an other user, the other user not one of the specific users, and the storage access request is for creation of the prohibited file type, and wherein executing the set of storage rules comprises: denying the storage access request.

15. The non-transitory computer-readable medium of claim 10, wherein the machine-executable code, when executed by the machine, further causes the machine to:
receive a request from the partner computing system to retrieve results of previous storage access requests received by the storage system over a specified time period;
identify the previous storage access requests over the specified time period and the results of the previous storage access requests, the results indicating whether each of the storage access requests were allowed; and
transmit the previous storage access requests to the partner computing system.

16. The non-transitory computer-readable medium of claim 10, wherein the machine-executable code, when executed by the machine, further causes the machine to:
responsive to a request from the partner computing system to purge the set of rules from the rule set repository, delete the set of storage rules;
receive a second storage access request from the client computing device; and
transmit an event notification of the second storage access request to the partner computing system.

17. The non-transitory computer-readable medium of claim 10, wherein the set of storage rules defining the storage access policy further specify a set of directories for the one or more file access operations and a maximum disk storage quota for at least one of the set of directories.

18. The non-transitory computer-readable medium of claim 10 wherein executing the set of storage rules comprises: responsive to determining that the storage access request is for creating a file in the one of the set of directories associated with a maximum disk storage quota, the file having a file size greater than the maximum disk storage quota, or is for increasing an existing file size by an amount greater than the maximum disk storage quota, transmitting the event notification of the storage access request to the partner computing system.

19. A storage system, comprising:
a processor device; and
a memory device including program code stored thereon, wherein the program code, upon execution by the processor device, performs operations comprising:
receiving, at the storage system from a partner computing system, a set of storage rules defining a storage access policy for specific users, specific user groups, or specific client computing devices, the storage access policy allowing the specific users, the specific user groups, or the specific client computing devices to perform one or more storage access operations within a file system hosted by the storage system;
responsive to verifying that the set of storage rules adhere to a storage rule language syntax, storing the set of storage rules within a rule set repository accessible by the storage system; and
upon receiving a storage access request from a client computing device, comparing the storage access request against the storage access policy by executing the set of storage rules to allow or deny the storage access request according to the set of storage rules.

20. The storage system of claim 19, wherein executing the set of storage rules comprises: responsive to determining that the storage access request satisfies all of the set of storage rules, allowing the storage access request and storing a result of the storage access request within the rule set repository.
